(19) United States
(12) Patent Application Publication
(10) Pub. No.: US 2025/0018667 A1
(43) Pub. Date: Jan. 16, 2025

(54) MOISTURIZED CONTACT LENS AND METHOD OF MANUFACTURING THE SAME

(71) Applicant: JU-LIANG CHENG, DOULIU CITY (TW)

(72) Inventor: JU-LIANG CHENG, DOULIU CITY (TW)

(21) Appl. No.: 18/352,710

(22) Filed: Jul. 14, 2023

(51) Int. Cl. B29D 11/00; G02C 7/04

(52) U.S. Cl. CPC B29D 11/0025; B29D 11/00057; B29D 11/00067; G02C 7/04

(57) ABSTRACT

A moisturized contact lens and a method of manufacturing the same are provided. A lens of at least one quasi-contact lens is placed on a pallet of a modification processing machine for contact lenses. Then an electric arc generating unit is driven by a feed unit of the modification processing machine for contact lenses to remove impurities clogged pores of a lens of the quasi-contact lens and form circular grooves on surface of the lens of the quasi-contact lens. Thereby breathability, oxygen permeability, and hydrophilicity of the contact lens are restored. The circular grooves are for storage of tears so that wettability between eyeballs and the contact lens can be maintained for a long time and tear circulation is improved. Users won't have discomfort and dry eyes caused by insufficient moisture even wearing the contact lens for a long time and eye drops or artificial tears are not used.

### BACKGROUND OF THE INVENTION

### Field of the Invention

The present invention relates to a contact lens, especially to a moisturized contact lens and a method of manufacturing the same.

### Description of Related Art

The common ways how contact lenses are made include lathe cutting, spin casting, and cast molding. The lathe cutting process is complicated and thus not suitable for mass-production while the spin casting is difficult to be applied to production of lenses with high complexity. As to the cast molding, it is suitable for mass production and manufacturing of lenses with high complexity. Thereby most of contact lenses available now are produced by the cast molding. A liquid material is injected into a designed mold. Then the liquid material in the mold is hardened by UV curing or thermal curing. After cooling down, remove the mold to get lenses for contact lens. The cooling process takes about 1 min in the cast molding. In practice, the mold is removed immediately after curing and forming of the liquid material in the mold for higher efficiency. Thus pores originally designed for breathability on the lenses for contact lens are easy to have shortcomings such as adhesion and clogging due to fast cooling of high temperature demoulding and intense contraction. Thereby the contact lenses available now are easy to have different problems including lack of oxygen to the eyeball and uncomfortable feeling during wearing caused by poor breathability, oxygen permeability, and lack of hydrophilicity.

The contact lens covers a surface of an eyeball while wearing. Besides impact on secretion of tears, the tears are easily squeezed out. Thus users will have discomfort and dry eyes caused by insufficient moisture after wearing the contact lens for a long time. People who wear contact lenses use eye drops or artificial tears to get relief from the dry eyes. However, periodic use of eye drops or artificial tears is not convenient for users wearing contact lenses, cost of the eye drops or artificial tears is also a burden for users. Once the eye drops or artificial tears used contain preservatives, there is a risk of corneal ulcer. Thus the key point of research and development of the contact lenses is how to increase water content of the contact lens. Most of methods of increasing the water content of the contact lens available now mainly focus on material improvement. Refer to Chinese Pat. Pub. No. 106800626A “silicon hydrogel composition and silicone hydrogel contact lenses made from the composition”, a silicon hydrogel composition which includes at least one silicone macromere, a hydroxyl-functionalized silicone-containing monomer, a first hydrophibic monomer and at least one crosslinker is provided. The silicon hydrogel contact lenses made from the composition have high oxygen permeability and high moisturizing capability. Also refer to PCT Pat. Pub. No. WO2023082166A1 “contact lens and method of manufacturing the same”, a contact lens includes a lens and a hydrophilic polymer layer which are intertwined with each other. The hydrophilic polymer layer and the lens form an interpenetrating polymer network or a semi-interpenetrating polymer network. The hydrophilic polymer layer is formed by performing a polymerization reaction between an initiator adsorbed on a lens and at least one hydrophilic vinyl monomer. Thereby the contact lens has hydrophilic property. However, although the material modification can increase water content and hydrophilic property of the contract lens, not only the manufacturing process is complicated, time-consuming and easy to have errors, the production cost is also higher. The material modification method is unable to meet industrial requirements of high efficiency and low cost now.

### SUMMARY OF THE INVENTION

Therefore, it is a primary object of the present invention to provide a moisturized contact lens and a method of manufacturing the same in which circular grooves for storage of tears are formed easily on surface of a lens of the contact lens and impurities clogged pores of the lens of the contact lens are removed so that the pores are unblocked to restore breathability, oxygen permeability, and hydrophilicity of the contact lens. Thereby wettability between eyeball and the contact lens can be maintained for a long time.

In order to achieve the above objects, a method of manufacturing moisturized contact lenses according to the present invention is provided. First placing a contact lens of at least one quasi-contact lens on a pallet of a modification processing machine for contact lenses. Then driving an electric arc generating unit to remove impurities clogged pores of a lens of the quasi-contact lens and forming circular grooves on a surface of the lens of the quasi-contact lens by a feed unit of the modification processing machine for contact lenses to produce a moisturized contact lens. Thereby breathability, oxygen permeability, and hydrophilicity of the contact lens are restored. The design of the circular grooves is for storage of tears so that wettability between eyeballs and the contact lens can be maintained for a long time and tear circulation is better. The problems of users including discomfort and dry eyes after wearing the contact lens for a long time and frequent use of eye drops or artificial tears can be solved. Therefore, the contact lenses offer convenience and comfort during wearing.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a flow chart showing steps of an embodiment according to the present invention;

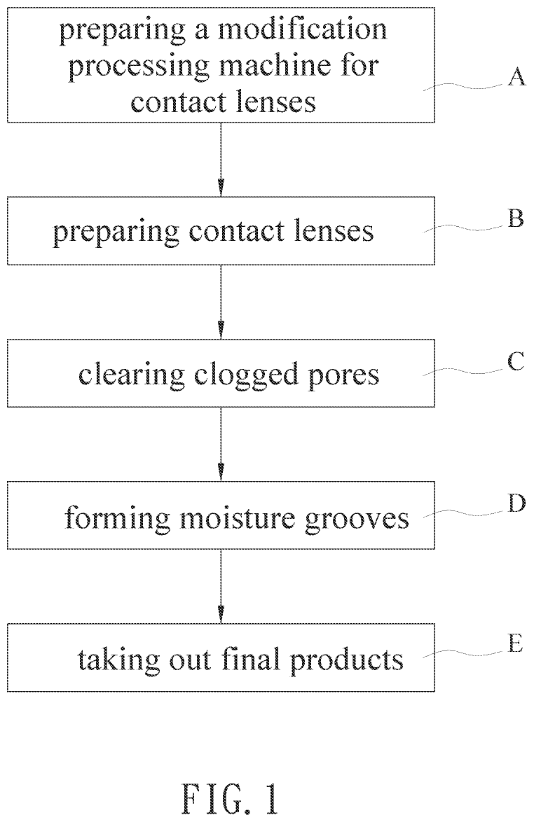

FIG. 2 is a perspective view of a modification processing machine for contact lenses of an embodiment according to the present invention;

FIG. 3 is a partial enlarged perspective view of a modification processing machine for contact lenses of an embodiment according to the present invention;

FIG. 4 is a front view of a modification processing machine for contact lenses of an embodiment according to the present invention;

FIG. 5 is a schematic drawing showing a modification processing machine for contact lenses in use of an embodiment according to the present invention;

FIG. 6 is a perspective view of a moisturized contact lens of an embodiment according to the present invention;

FIG. 7 is a top view of a moisturized contact lens of an embodiment according to the present invention;

FIG. 8 is a sectional view of a moisturized contact lens of an embodiment according to the present invention;

FIG. 9 is a sectional view of a moisturized contact lens of another embodiment according to the present invention.

### DETAILED DESCRIPTION OF THE PREFERRED EMBODIMENT

A method of manufacturing moisturized contact lenses includes the following steps.

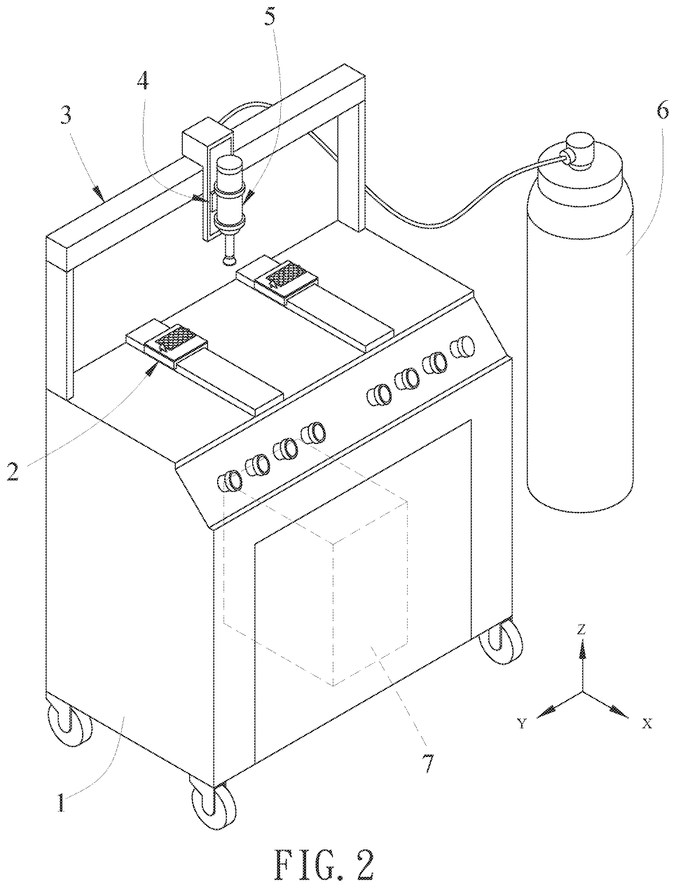

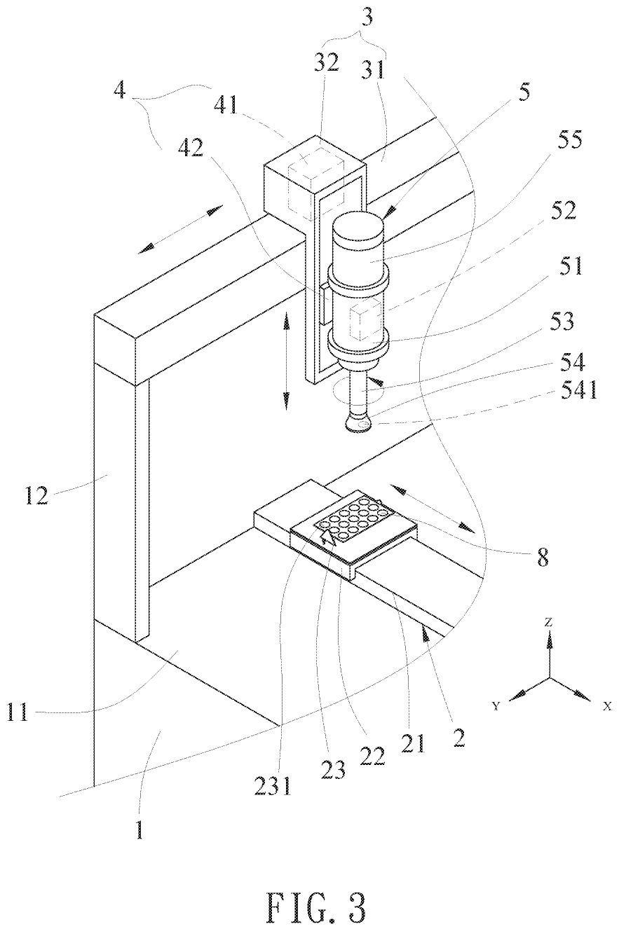

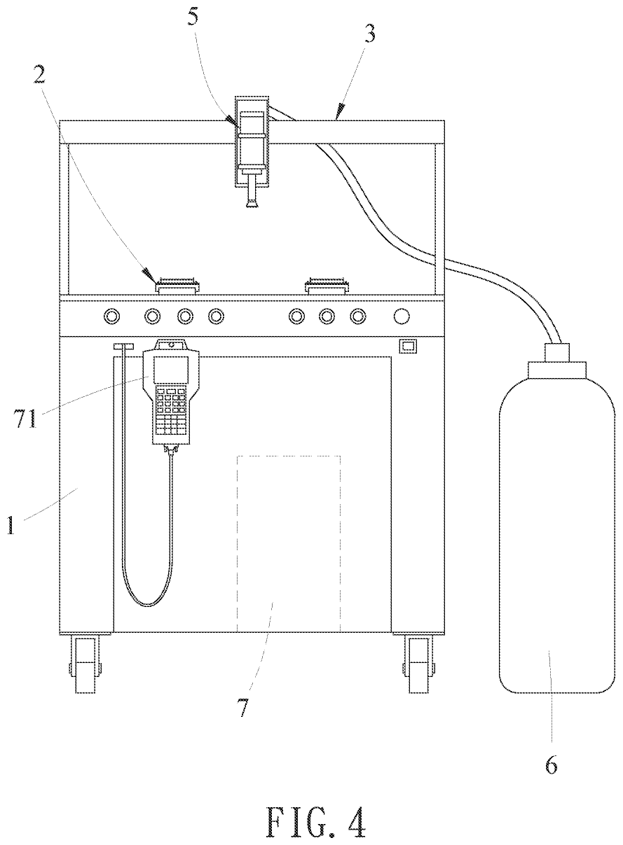

A. preparing a modification processing machine for contact lenses: refer to FIG. 2 and FIG. 3, the modification processing machine for contact lenses includes a machine body 1 provided with a table surface 11 and two supports rods 12 on two opposite sides thereof correspondingly, at least one first axial feed unit 2 disposed on the table surface 11 of the machine body 1, a second axial feed unit 3, a third axial feed unit 4, an electric arc generating unit 5, a gas supply unit 6, and a control unit 7. The first axial feed unit 2 is an X-axis feed unit which includes a first drive module 21 and a first displacement module 22 connected with and driven by the first drive module 21. The first drive module 21 is fixed on the table surface 11 of the machine body 1 while the first displacement module 22 is provided with a pallet 23 at which at least one recessed workpiece positioning portion 231 is arranged. The second axial feed unit 3 is a Y-axis feed unit which includes a second drive module 31 and a second displacement module 32 connected with and driven by the second drive module 31. The second drive module 31 is fixed between the two supports rods 12 so that the second axial feed unit 3 is located over the first axial feed unit 2. As to the third axial feed unit 4, it is a Z-axis feed unit which includes a third drive module 41 arranged at the second displacement module 32 and a third displacement module 42 connected with and driven by the third drive module 41. The first axial feed unit 2, the second axial feed unit 3, and the third axial feed unit 4 can be linear guides. The electric arc generating unit 5 is disposed on the third displacement module 42 and composed of a main body 51 with a chamber therein, an arc generating module 52 mounted in the chamber of the main body 51, a hollow tube 53 arranged under the main body 51 and communicating with the chamber of the main body 51, a nozzle 54 arranged at a bottom of the hollow tube 53 and provided with at least one spray hole 541, and a rotating power module 55 disposed on the main body 51. The hollow tube 53 is connected with and driven by the rotating power module 55 while the spray hole 541 is eccentrically disposed on a bottom of the nozzle 54 and communicating with the hollow tube 53. The gas supply unit 6 used for supplying water-free working gas is connected and communicating with the chamber of the main body 51 of the electric arc generating unit 5 by a pipeline. The control unit 7 is a programmable logic controller (PLC). Also refer to FIG. 4, the control unit 7 is mounted in the machine body 1 while an operation module 71 is disposed outside the machine body 1. The control unit 7 with the operation module 71 is connected with the first axial feed unit 2, the second axial feed unit 3, the third axial feed unit 4, the electric arc generating unit 5, and the gas supply unit 6 for signal transmission.

B. preparing contact lenses: placing a lens 8 of at least one quasi-contact lens formed after demoulding on the workpiece positioning portion 231 of the pallet 23 on the modification processing machine for contact lenses and allowing one lateral surface of the lens 8 of the quasi-contact lens facing upward. In this embodiment, a plurality of lenses 8 of the quasi-contact lens is respectively mounted in a plurality of workpiece positioning portions 231 arranged in an array of the pallet 23.

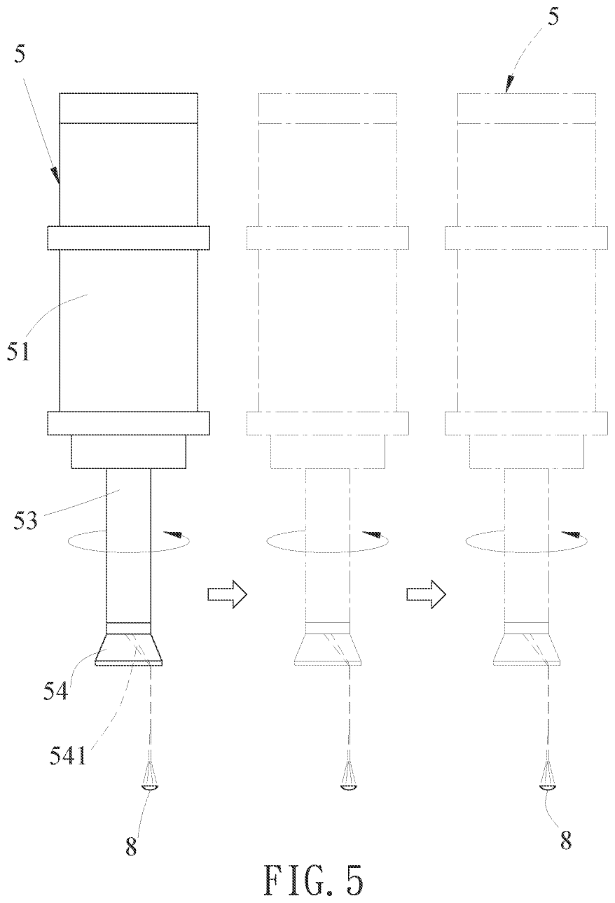

C. clearing clogged pores: operating the control unit 7 by the operation module 71 on the modification processing machine for contact lenses to drive the arc generating module 52 of the electric arc generating unit 5 working for generating electric arc. At the same time, the gas supply unit 6 introduces the water-free working gas into the chamber of the main body 51 of the electric arc generating unit 5. After entering the chamber of the main body 51, the working gas is ionized into plasma by the electric arc from the arc generating module 52. Later the plasma is entering into the hollow tube 53 under the main body 51. The hollow tube 53 is to driven to rotate by the rotating power module 55 so that the plasma is sprayed from the spray hole 541 of the nozzle 54 on the rotating hollow tube 53 to hit a surface of the lens 8 of the quasi-contact lens evenly. Thus impurities adhered to and clogged on the breathing pores of the lens 8 of the quasi-contact lens are removed and the pores are unblocked. At the same time, micro-burrs on the lens 8 of the quasi-contact lens formed during release of the lens 8 of the quasi-contact lens from a mold are also removed. Also refer to FIG. 5, the control unit 7 makes the second drive module 31 of the second axial feed unit 3 to drive the second displacement module 32 with the electric arc generating unit 5 thereon to move from left to right along the Y-axis. Thereby clearing of the clogged pores of the lenses 8 of the quasi-contact lens at the first row of the pallet 23 has been completed. The control unit 7 further controls the first drive module 21 of the first axial feed unit 2 to drive the first displacement module 22 together with the pallet 23 thereon to move backward along the X-axis, being far away from the electric arc generating unit 5. Then the control unit 7 drives the second axial feed unit 3 to move the electric arc generating unit 5 from right to left and back to the original position and the electric arc generating unit 5 stops working temporarily. The first axial feed unit 2 is driven by the control unit 7 to make the pallet 23 move forward so that lenses 8 of the quasi-contact lens at the second row of the pallet 23 are located corresponding to the electric arc generating unit 5. Then the electric arc generating unit 5 is driven to output the plasma for clearing the clogged pores of the lenses 8 of the quasi-contact lens on the second row and removing the burrs. Thereby clearing of the clogged pores and deburring of all of the lenses 8 of the quasi-contact lens on the pallet 23 are completed by repeating the above process.

D. forming moisture grooves: operating the control unit 7 by the operation module 71 to adjust an output power of the electric arc generating unit 5 and parameters of the gas supply unit 6 such as working gas flow, carrier gas flow, etc. for increasing strength of the plasma sprayed from the spray hole 541 of the nozzle 54 for hitting the lens 8 of the quasi-contact lens. The hollow tube 53 is driven to rotate by the rotating power module 55 to make at least one circular groove form on the surface of the lens 8 of the quasi-contact lens by plasma etching while the plasma is sprayed from the eccentrically-arranged spray hole 541 of the nozzle 54. Then the control unit 7 drives the second axial feed unit 3 and the first axial feed unit 2 respectively to move the electric arc generating unit 5 and the pallet 23 for work in order to finish groove processing of all of the lenses 8 of the quasi-contact lens on the pallet 23.

E. taking out final products: after completion of the processing of all the lenses 8 of the quasi-contact lens on the pallet 23, the control unit 7 temporarily stops operation of the electric arc generating unit 5 and drives the first axial feed unit 2 and the second axial feed unit 3 respectively to move the pallet 23 and the electric arc generating unit 5 back to the original positions. Then the third axial feed unit 4 is allowed to drive the electric arc generating unit 5 moving upward along the X-axis to be away from the pallet 23. Next take the processed lenses 8 of the quasi-contact lens out of the pallet 23 and place a next batch of the lenses 8 of the quasi-contact lens to be processed on the pallet 23.

Thereby the clogged pores of the lens 8 of the contract lens can be cleared easily and conveniently by the present method. Oxygen permeability and hydrophilicity of the lens 8 of the contact lens are further improved. At the same time, the micro-burrs generated during release of the lens 8 of the contact lens from the mold are removed to reduce foreign body sensation caused by contact between the contact lens and cornea. A moisturized contact lens with circular grooves on surface thereof is also produced. Moreover, the water-free working gas helps keep surface modification more stable for long-lasting effect. Thus structures formed after surface modification such as the circular grooves will not disappear or the lens 8 will not return to original state easily. After many times of experiments, it is learned that a “pseudo-effect” is provided once the working gas containing water is used. The structures such as the circular grooves will disappear and the surface of the lens 8 comes back to the smooth surface having no grooves after a period of time.

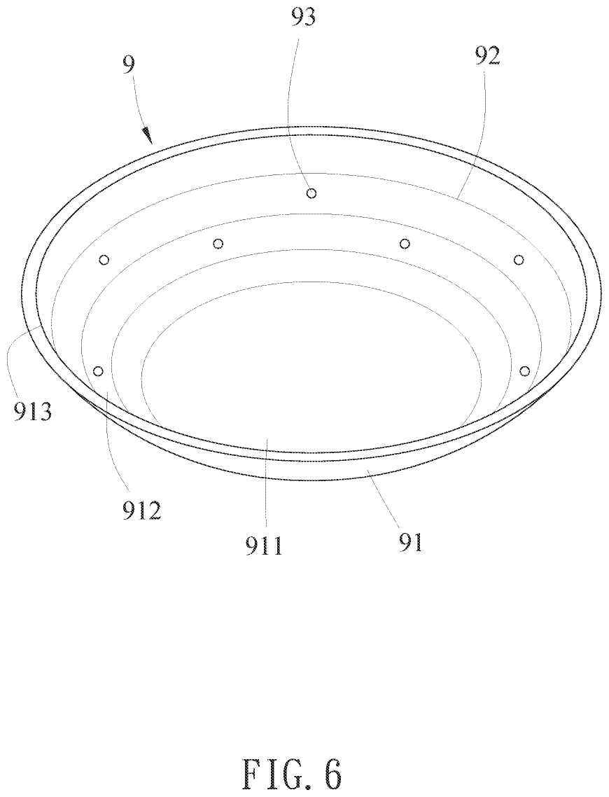

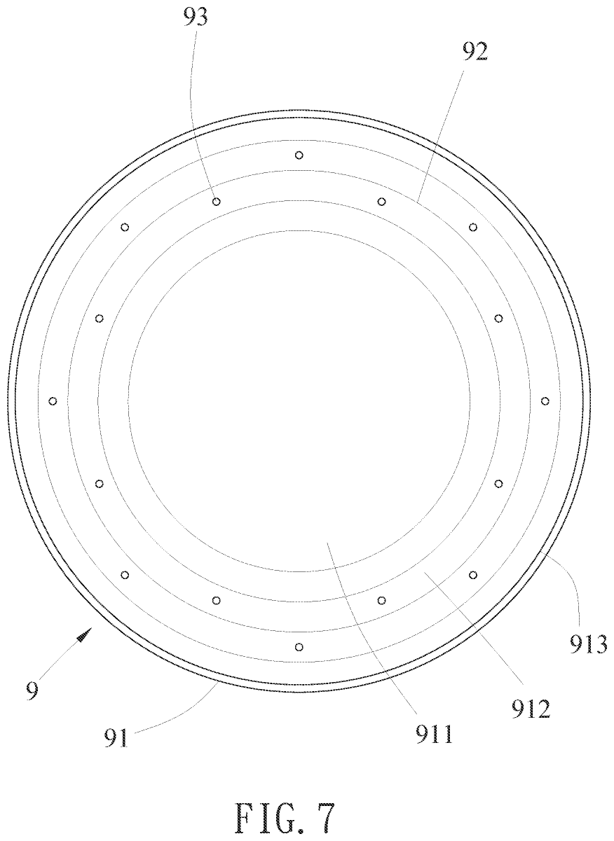

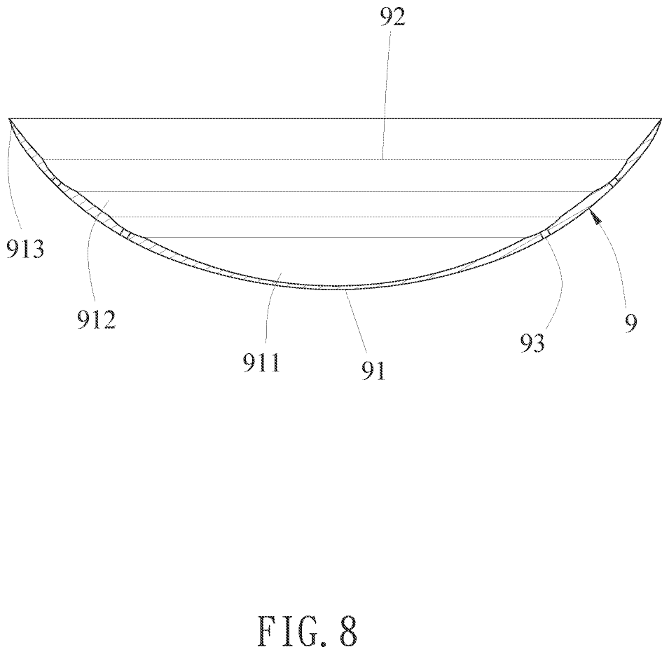

Refer to FIG. 6, FIG. 7, and FIG. 8, a moisturized contact lens 9 according to the present invention includes a curved lens body 91 having a first surface and a second surface opposite to each other. The first surface is concave while the second surface is convex. The curved lens body 91 includes an optical area 911, a non-optical area 912, and a peripheral area 913 from a center to the outside in turn. At least one circular groove 92 is formed on the non-optical area 912 of the first surface of the lens body 91. In this embodiment, a plurality concentric circular grooves 92 is formed on the non-optical area 912 of the first surface of the lens body 91. A plurality of pores 93 penetrating the first surface and the second surface of the lens body 91 is formed on the non-optical area 912 of the lens body 91.

While using the moisturized contact lens 9 of the present invention, the concave first surface of the lens body 91 covers a surface of eyeball. Thus breathability and oxygen permeability are provided by the plurality of the pores 93 on the lens body 91 while wearing the moisturized contact lens 9. When tears are secreted and spread out to lubricate the eyeball, the tears are able to be stored at the circular grooves 92 on the non-optical area 912, without being evaporated or squeezed out easily. Thereby water content and wettability between the eyeball and the lens body 91 can be maintained for a long time and tear circulation is also better. At the same time, ester formation on the surface of the lens body 91 caused by tear protein deposition is reduced so that uses feel more comfortable while wearing the contact lens. Moreover, due to high and long-lasting wettability between the eyeball and the lens body 91 resulted from the tears stored at the circular grooves 92 of the moisturized contact lens 9, the user will not have discomfort and dry eyes caused by insufficient moisture even wearing the contact lens 9 for a long time. There is no need to use eye drops or artificial tears to get relief from the dry eyes and thus the contact lenses are more convenient to wear. Cost of the eye drops and artificial tears can also be saved. The safety of the contact lenses for users is improved because that a risk of corneal ulcer associated with preservatives in the eye drops or artificial tears is minimized.

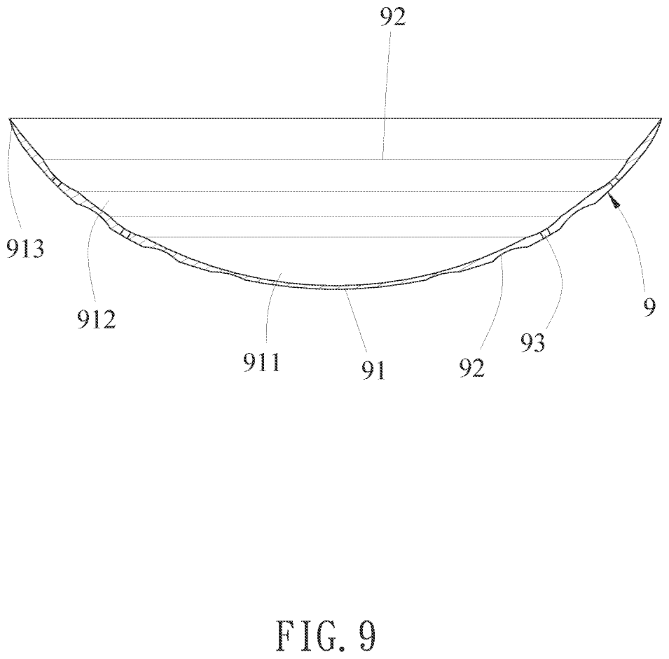

As shown in FIG. 9, besides being formed on the first surface of the lens body 91, the circular grooves 92 can also be formed on the non-optical area 912 of the second surface of the lens body 91. The step of clearing clogged pores can be omitted and the circular grooves 92 are directly formed on the contact lens. In another embodiment, the step of forming moisture grooves is carried out first and then the step of clearing clogged pores is run. The step of clearing the clogged pores can be omitted and the step of forming the circular grooves on the contact lens is run directly. Or first take the step of forming the circular grooves for storage of tears and then run the step of clearing the clogged pores.

In summary, the present invention has the following advantages:

1. The present method uses the electric arc for ionization of the working gas to form plasma. Then the plasma is sprayed to hit a surface of the lens of the contact lens at high speed. Thereby the impurities clogged the pores of the lens of the contact lens are removed easily and conveniently. At least one circular groove for storage of tears is also formed on the surface of the lens. The manufacturing process is fast and cost-effective and thus the contact lenses are competitive.

2. Both the electric arc generating unit and the pallet are connected with a plurality of axial feed units. Thereby accessible range of the electric arc generating unit is increased. By the rotating power module that drives the nozzle to rotate, the plasma is evenly sprayed and hit the lens of the contact lens to remove impurities clogged the pores of the lens and form the circular grooves more quickly and stably.

3. The parameters including the output power of the electric arc generating unit, the working gas flow, and the carrier gas flow of the gas supply unit, etc. can be adjusted by the control unit in order to meet requirements for removal of impurities clogged the pores of the lens of the contact lens and formation of the circular grooves.

4. The present method uses the water-free working which helps the surface modification of the lens of the contact lens become more stable and long-lasting. Thus the structure such as the circular grooves formed will not disappear or the lens will not return to the original state easily after the surface modification.

5. The impurities adhered to and clogged the pores of the lens of the contact lens caused by high temperature demoulding can be cleared by the present method. Thus breathability and oxygen permeability of the pores of the lens of the contact lens are restored. The micro-burrs generated during release of the lens of the contact lens from the mold are also removed to reduce foreign body sensation caused by the lens in contact with cornea while wearing the contact lens.

6. The surface of the lens body of the moisturized contact lens is provided with circular grooves. Thus tears can be stored in the circular grooves without being evaporated or squeezed out easily. Thereby water content and wettability between the eyeball and the lens body can be maintained for a long term and tear circulation is enhanced. At the same time, ester formation on the surface of the contact lens caused by tear protein deposition is reduced. The contact lenses provide users more comfortable wearing experience.

7. By design of the circular grooves arranged at the surface of the lens body of the moisturized contact lens, tears can be stored in the circular grooves. Thus the wettability between the eyeball and the lens body can be maintained for a long term and tear circulation is enhanced. There is no need to use eye drops or artificial tears to get relief from the dry eyes and the contact lenses are more convenient to use.

8. Owing to tears stored in the circular grooves disposed on the surface of the lens body of the moisturized contact lens, the wettability between the eyeball and the lens body can be maintained for a long term. Thus there is no need to use eye drops or artificial tears and the cost for the eye drops or artificial tears is saved. The risk of corneal ulcer caused by preservatives in the eye drops or artificial tears can also be avoided. The safety of the contact lenses for users is further improved.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A method of manufacturing moisturized contact lenses comprising the steps of:
placing a lens of at least one quasi-contact lens on a pallet of a modification processing machine for contact lenses;
driving at least one of an electric arc generating unit and the pallet to move by at least one feed unit of the modification processing machine for contact lenses while the electric arc generating unit is connected with a gas supply unit;
introducing water-free working gas from the gas supply unit to the electric arc generating unit and ionizing the working gas into plasma by the electric arc generating unit; and
spraying the plasma from a rotating nozzle arranged at the electric arc generating unit to hit a surface of the lens of the quasi-contact lens for formation of at least one circular groove on the surface of the lens of the quasi-contact lens.

2. The method as claimed in claim 1, wherein the plasma output from the electric arc generating unit is sprayed to hit the surface of the lens of the quasi-contact lens for clearing impurities clogged pores of the lens of the quasi-contact lens and removing micro-burrs on the lens of the quasi-contact lens.

3. The method as claimed in claim 1, wherein the feed unit of the modification processing machine for contact lenses includes a first axial feed unit and a second axial feed unit; the first axial feed unit includes a first drive module and a first displacement module connected with and driven by the first drive module while the second axial feed unit includes a second drive module and a second displacement module connected with and driven by the second drive module; the modification processing machine for contact lenses includes a machine body; the first drive module of the first axial feed unit is fixed on a table surface of the machine body and the pallet is arranged at the first displacement module of the first axial feed unit; the machine body is provided with two support rods opposite to each other; the second drive module of the second axial feed unit is fixed between the two supports rods so that the second axial feed unit is located over the first axial feed unit; the electric arc generating unit is disposed on the second displacement module.

4. The method as claimed in claim 3, wherein the modification processing machine for contact lenses further includes a third axial feed unit composed of a third drive module and a third displacement module connected with and driven by the third drive module; the third drive module is arranged at the second displacement module and the electric arc generating unit is disposed on the third displacement module.

5. The method as claimed in claim 1, wherein the electric arc generating unit of the modification processing machine for contact lenses includes a main body with a chamber therein, an arc generating module mounted in the chamber of the main body, a hollow tube which is arranged under the main body and communicating with the chamber of the main body, a nozzle arranged at a bottom of the hollow tube and provided with at least one spray hole, and a rotating power module disposed on the main body; the hollow tube is connected with and driven by the rotating power module while the spray hole is eccentrically disposed on a bottom of the nozzle and communicating with the hollow tube.

6. A moisturized contact lens comprising
a lens body provided with a first surface and a second surface opposite to the first surface; and
at least one circular groove formed on the first surface of the lens body.

7. The moisturized contact lens as claimed in claim 6, wherein a plurality of the circular grooves is formed on the first surface of the lens body and the circular grooves are arranged concentrically.

8. The moisturized contact lens as claimed in claim 6, wherein the lens body includes an optical area, a non-optical area, and a peripheral area from a center to the outside of the lens body in turn; the circular groove is formed on the non-optical area of the first surface of the lens body.

9. The moisturized contact lens as claimed in claim 6, wherein at least one circular groove is formed on the second surface of the lens body.

10. The moisturized contact lens as claimed in claim 6, wherein a plurality of pores penetrating the first surface and the second surface of the lens body is formed on the lens body.
